(19) United States
(12) Patent Application Publication
(10) Pub. No.: US 2017/0312907 A1
(43) Pub. Date: Nov. 2, 2017

(54) Ratcheting or Non-Ratcheting Driver With Configurable Bit Storage

(71) Applicant: Robert Joseph Gallegos, Fremont, CA (US)

(72) Inventor: Robert Joseph Gallegos, Fremont, CA (US)

(21) Appl. No.: 15/584,891

(22) Filed: May 2, 2017

Related U.S. Application Data
(60) Provisional application No. 62/330,770, filed on May 2, 2016.

(51) Int. Cl. B25G 1/08; B25B 15/00; B25B 15/04; B25H 3/00

(52) U.S. Cl. CPC B25G 1/085; B25H 3/003; B25B 15/004; B25B 15/04

(57) ABSTRACT

A ratcheting or non-ratcheting bit driver with a bit storage or “cartridge” that fits in the hollow portion of the driver handle. The bit storage or “cartridge” enables access to bits from both ends of all bits at a perpendicular orientation to the main axis of the handle while contained within the handle. The device remains in one piece rather than separating the assembly into two pieces, a handle and a cartridge during use.

### CROSS REFERENCE TO RELATED APPLICATIONS:

This application claims priority from U.S. patent application Ser. No. 62/334,187, entitled “A Ratcheting or Non-Ratcheting Driver With Configurable Bit Storage”, filed on 2 MAY-2016. The benefit under 35 USC §119(e) of the United States provisional application is hereby claimed, and the aforementioned application is hereby incorporated herein by reference.

### TECHNICAL FIELD OF THE INVENTION

The present invention relates to the field of hand held tools. More specifically, the present invention relates to the field of bit drivers and related hand tools.

### BACKGROUND OF THE INVENTION

Tools requiring bits typically utilize a “loose bit” solution. According to this solution, a hand tool or similar tool is separate from the bit holder containing bits. Workers face several problems with this configuration due to the many components and the hassle corresponding to the methods of accessing them.

According to the “loose bit” solution, the user must set down the hand tool, pick up the bit holder with one hand, use the other hand to choose and access a desired bit from the bit holder, set down the bit holder and finally couple the selected bit to the hand tool. This traditional method of changing bits requires many parts, many steps and many motions.

Alternatively, a user of a “loose bit” tool system might attempt to hold the numerous tools simultaneously, for example, the driver, the bit holder, the current bit, the replacement bit, etc., as well as holding work pieces. This practice often times results in a load that is too heavy or awkward for the user to work dexterously and in a constant potential to drop one of these components.

Finally, it is particularly difficult to perform the tasks required according to the “loose bit” solution while on a ladder or in other positions requiring great precision or balance.\ The prior art teaches a solution for a large portion of the problem, however, there are still three items (handle, cartridge, and workpiece) that need to be manipulated in order to both insert/extract a bit or to test fit a bit while it is still in the cartridge.

### TABLE OF NUMERICAL REFERENCES

### LIST OF ELEMENTS

1. Non-Ratcheting Driver

2. Configurable Bit Storage

3. Ratching Driver

4. Driver Handle—with or without over mold

5. Bit Storage Cartridge

6. Bit Replacement Mode—Rotating Cartridge

7. Back access to bits—10 at once

8. Front access to bits—10 at once

9. Replacement Cartridges

10. Detachable Shaft

11. Bit Storage Port or holes

12. Removable Cartridge

13. Bit Removal Manually

14. Smaller Driver with Storage

15. Stubby Driver with Storage

16. Release Button for Socket Storage

17. Front and back access to Sockets

18. Top Tab Rotation—Socket Cartridge

19. Release Button for Bit Storage

20. Front and back access to Bits

21. Top Tab Rotation—Bit Cartridge

22. Cartridge Fins to retain bits

23. Hex Bits

24. Tri-lobe Handle

### SUMMARY OF THE INVENTION

The present invention is comprised of a ratcheting bit driver with a bit storage or “cartridge” that fits in the hollow portion of the driver handle. Other prior art devices provide bit holders either integral to the handle, separate from the handle, or detachable from the handle, but no prior art comprises a means to access bits from both ends of all bits at a perpendicular orientation to the main axis of the handle while contained within the handle.

A benefit of this aspect of the present invention is that, compared to the prior art which requires the handle and cartridge to be decoupled in order to access the bits, the present invention remains in “one piece” rather than separating the assembly into two pieces (handle and cartridge). The prior art teaches a solution for a large portion of the problem, however, there are still three items (handle, cartridge, and workpiece) that need to be manipulated in order to both insert/extract a bit or to test fit a bit while it is still in the cartridge.

### DESCRIPTION OF THE RELATED ART

Referring to FIG. 14, a conventional ratchet device disclosed in Taiwanese Patent No. M342913 includes a mounting member 1, two pawl members 2 mounted to the mounting member 1, a U-shaped resilient member 3 mounted to the mounting member 1, a direction-switching ring 4 sleeved on the mounting member 1, and a ratchet wheel 5 sleeved on the mounting member 1. The mounting member 1 has a U-shaped groove 101 for receiving the resilient member 3, and two accommodating grooves 102 located respectively at two sides of the U-shaped groove 101 for receiving the pawl members 2, respectively. The direction-switching ring 4 has an inner peripheral surface 401 and two positioning grooves 402 formed in the inner peripheral surface 401 and aligned respectively with the pawl members 2. The ratchet wheel 5 has a plurality of teeth 501. When the switching member 4 is disposed at a middle position, the pawl members 2 are biased by free ends 301 of the resilient member 3 to engage the positioning grooves 402, respectively, and engage the teeth 501 of the ratchet wheel 5. At this time, the ratchet wheel 5 can be rotated in two directions through operation of the mounting member 1.

When the switching member 4 is rotated in a direction, such that one of the pawl members 2 is pressed by the inner peripheral surface 401 to separate from the teeth 501, and the other of the pawl members 2 remains within the corresponding positioning groove 402 and engages the teeth 501, the ratchet wheel 5 is rotatable in only a single direction.

Many such various of a conventional ratchet device and various designs for the components are well known in the prior art. The present invention is not directed to or concerned with the mechanism and components enabling the ratcheting mechanism as long as the selected ratcheting mechanism is of sufficient size to be retained in the end of the handle closes to the workpiece/bit without effecting storage, or size of the handle and the removable cartridge taught by the present invention.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1a is a perspective view of a non-ratcheting driver with configurable bit storage taught by the present invention.

FIG. 1b is a perspective view of a ratcheting driver with configurable bit storage taught by the present invention.

FIG. 2a is a perspective view of a driver handle with or without over mold and a bit storage cartridge installed.

FIG. 2b illustrates the bit replacement mode of the present invention.

FIG. 3a illustrates the access to the back of all 10 bits at once of the present invention.

FIG. 3b illustrates the access to the front of all 10 bits at once, handy for test fitting and sizing fasteners before replacing bits.

FIG. 4 illustrates the how cartridges can be replaced with other cartridges offering a wide variety of drive style options as well as sockets.

FIG. 5 illustrates where, for the non-ratcheted version, the shaft can be detached and inserted directly into a bit storage port.

FIG. 6 illustrates where for either ratcheted or non-ratcheted version, the cartridge can be removed and positioned at the tip for bit replacement.

FIG. 7 illustrates where alternately, in either version, the bits can be removed by pushing them out from the tip end.

FIG. 8 illustrates where scaling down this concept could offer all of the same features and benefits in a smaller version.

FIG. 9 illustrates where stubby drivers can be offered with a limited set of bits as their own SKU's or as bonus items in a set.

FIG. 10a illustrates a use mode with a handle, with or without overmold, and bit storage cartridge installed.

FIG. 10b illustrates a bit replacement mode where rotating the cartridge from the top tab allows access to all 10 bits at once from both ends.

FIG. 11a illustrates a use mode with a handle, with or without overmold, and bit storage cartridge installed.

FIG. 11b illustrates a bit replacement mode where rotating the cartridge from the top tab allows access to all 9 bits at once from both ends.

FIG. 11c illustrates a detailed view where the bits are showing being separated from the bit storage ports.

FIGS. 12a and 12b illustrated the fins used to retain the bits in the cartridge.

FIGS. 13a, 13b, and 13c a tri-lobe handle shape as taught by an alternative embodiment of the present invention.

FIG. 14 is an exploded perspective view of a conventional ratchet device disclosed in Taiwanese Patent No. M342913.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

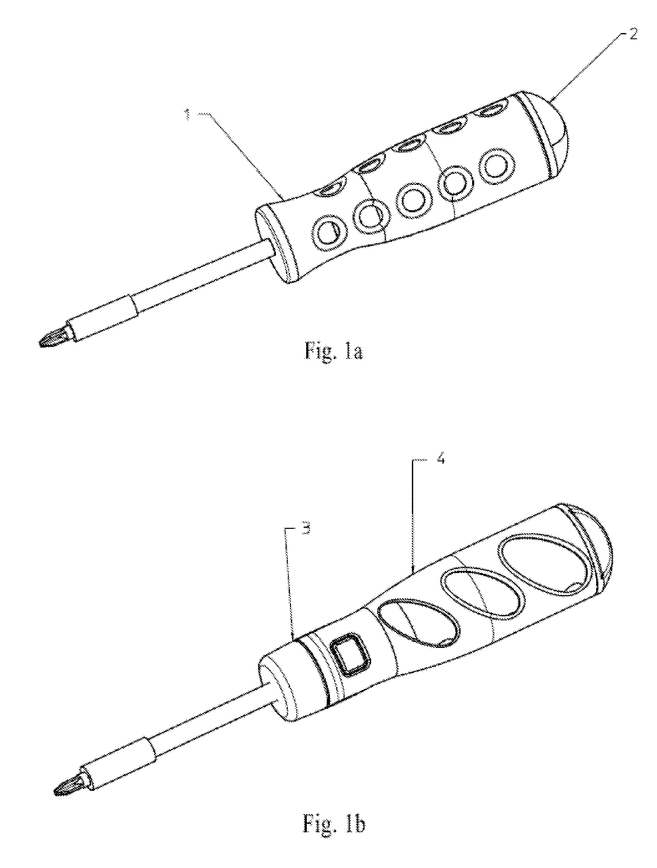

The present invention is a ratcheting bit driver 3 or non-ratcheting bit driver 1 with configurable bit storage 2 or a “cartridge” 5 that fits in the hollow portion of the driver handle 4 as shown in FIGS. 1a-1b. The bit storage or “cartridge” 5 enables access to bits 23 from both ends 7 and 8 of all bits at a perpendicular orientation to the main axis of the handle 4 while contained within the handle 4. The device remains in one piece rather than separating the assembly into two pieces, a handle 4 and a cartridge 5 during use.

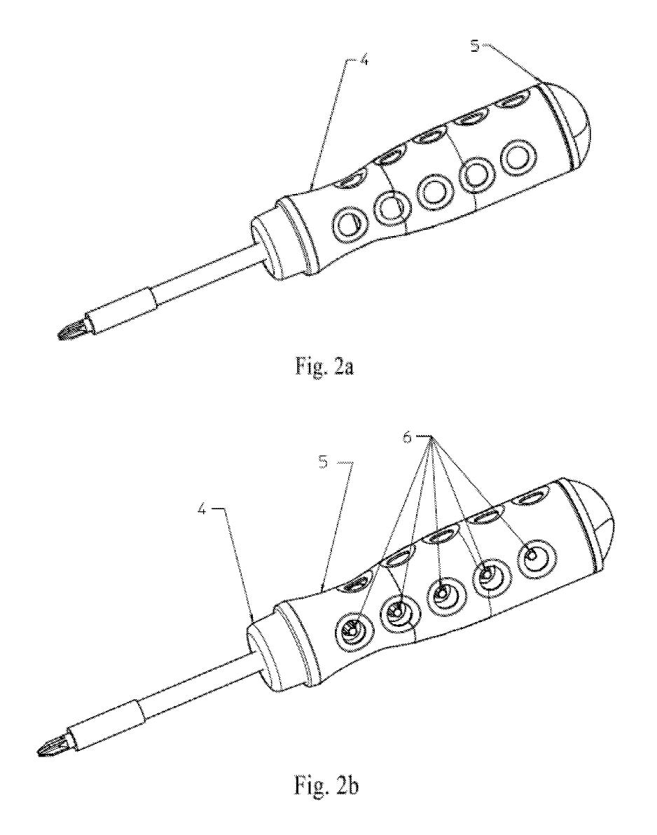

FIG. 2a illustrates the handle 4 with or without over mold in a use mode where the bit storage cartridge 5 is installed. The outer surface of the bit cartridge 5 is positioned to close off the bit access ports 11. In FIG. 2b, a bit replacement mode is shown where by rotating the cartridge 9 from the top tab allows access to all ten bits at once from both ends 7 and 8. Once rotated, bits 23 are presented from both the front and back ends 7 and 8. There is no need to remove cartridge 5 from the handle 4 as is required with several other products.

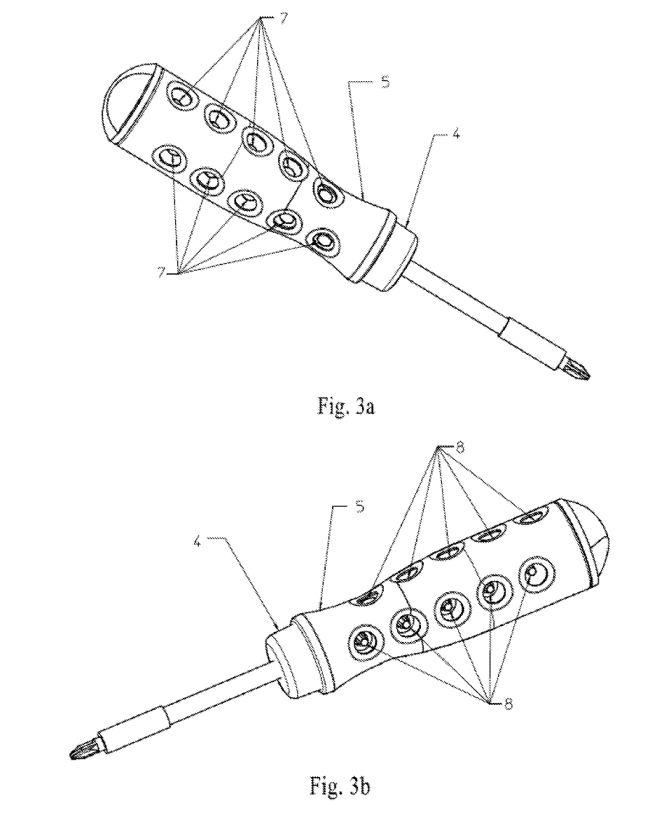

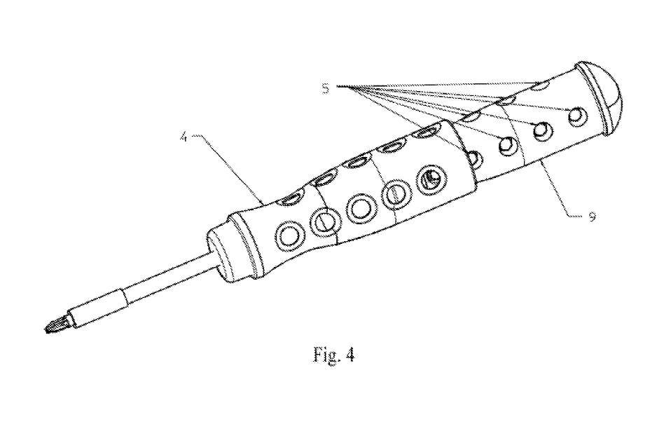

FIGS. 3a and 3b illustrate the access to the back 7 of all ten bits at once in a bit replacement mode which is handy for test fitting and sizing fasteners before replacing bits. Again, there is no need to remove cartridge 9 from the handle 4 as is required with several other products.

The present invention requires a minimum of only two items to be manipulated during a bit change operation: the handle 4 with integral, accessible bits, and the chosen bit.

The arrangement and spacing between bits 23 allows the bits 23 to be test fit to a fastener while in the cartridge/handle 4 assembly. The prior art, in contrast, requires that the cartridge 9 be removed from the handle 4 to do the same operation resulting in having to manipulate three items (a handle 4 , a cartridge 5, and a fastener), compared to two items of the present invention, a handle/cartridge assembly, and a fastener.

FIG. 4 illustrates where cartridges 5 can be replaced with other cartridges 9 offering a wide variety of drive style options as well as sockets in a bit cartridge replacement embodiment of the present invention.

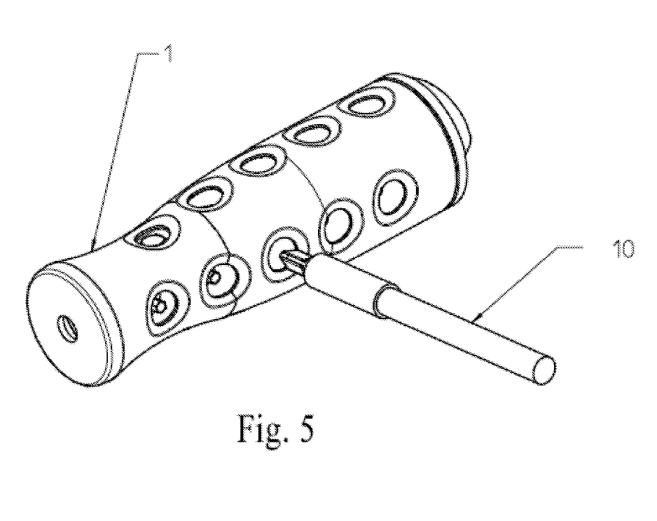

Now referring to FIG. 5, bit replacement mode 1 is illustrated. Here, for the non-ratcheted version, the shaft 10 can be detached and inserted directly into a bit storage port 11. This is a very handy feature that keeps the bits 23 from ever having to come loose from the assembly where they can get lost or dropped.

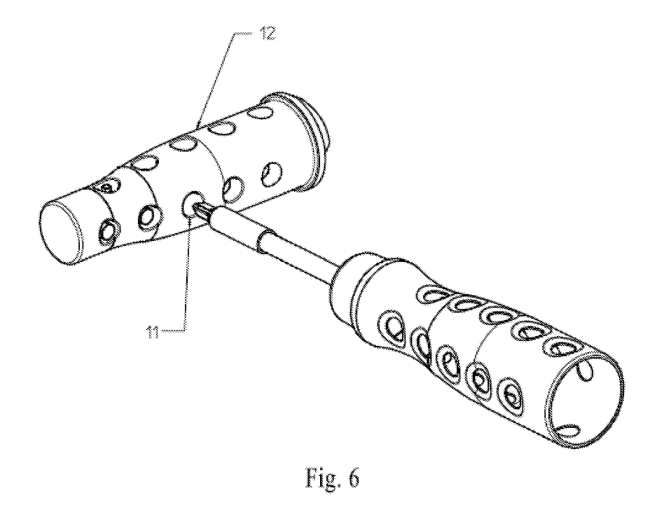

FIG. 6 illustrates bit replacement mode 2, where for either ratcheted or non-ratcheted version, the cartridge 12 can be removed and positioned at the tip for bit replacement.

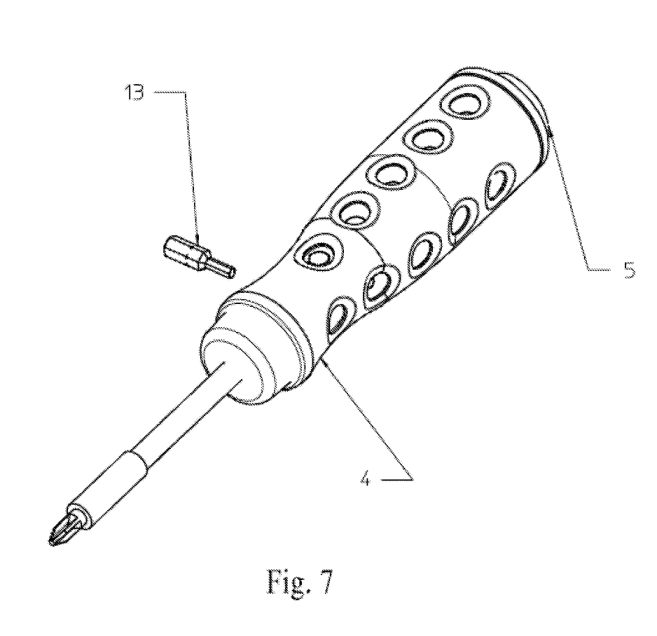

FIG. 7 illustrates bit replacement mode 3, where alternately, in either version, the bits 23 can be removed by pushing them out from the tip end 13.

When utilizing the “loose bit” method discussed in the Background Section, a user cannot conveniently test a bit for the proper fit with a screw or other work piece. Rather, the user must guess what size is appropriate, and then access bit after bit from a “loose bit” bit holder until the correct bit is found without a convenient way to “test fit” a bit.

The present invention also allows for changing a bit by directly coupling the receiving end of the shaft 10 with the mating end of a bit. This is done most commonly with a non-ratcheting version of the driver 1 such that the drive shaft 10 portion of the assembly is removable from the handle 4 portion, and then placed over the desired bit. Using a pushing force to couple the shaft 10 and the bit until it bottoms out against the cartridge 9, the shaft 10 is then twisted and pulled at the same time in order to extract the bit from the cartridge 9 while keeping the tip firmly and fully coupled with the shaft 10 receptacle—also with the aid of a magnet located at the bottom of the shaft bore.

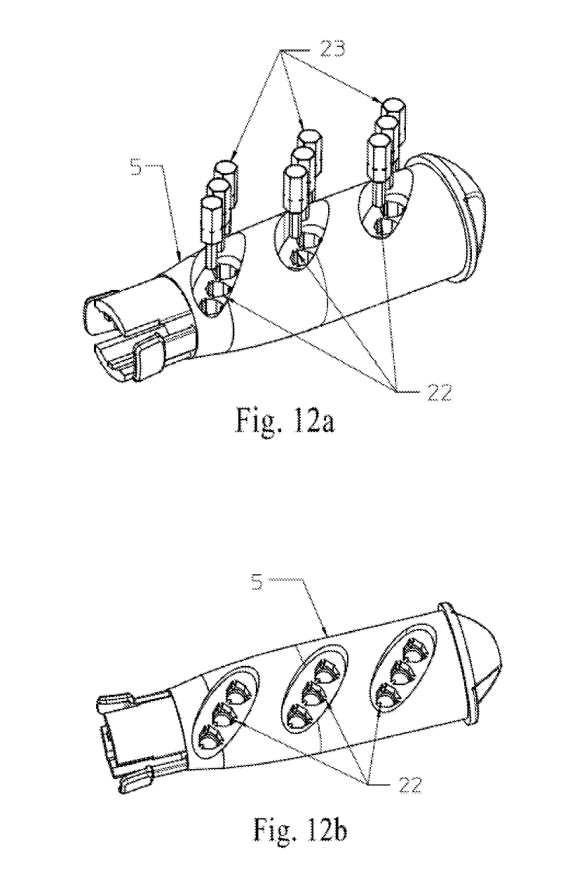

Now referring to FIGS. 12a and 12b, in order to aid in efficiently extracting the bit, the cartridge 9 comprises flexible fins 22 in a radial pattern around the bore for each bit. When the bit is rotated, the flexible fins 22 deflect in the direction of the twist and effectively reduce the amount of retention force.

In contrast, the prior art teaches where, a user is able to squeeze one or more nodes adjacent to a particular bit to aid in removing the bit from the frame. Squeezing the nodes causes the shape of the frame and the shape of the holes 11 to distort. Such distortion allows easier access to the bits. What is taught here still requires a second hand to be used to 1) squeeze the nodes with one hand, and 2) extract the bit using the shaft end of the handle with the other hand —still a more very awkward and inconvenient operation compared to the present invention since the handle, workpiece and fastener become even more difficult to hold and manipulate at the same time during this operation.

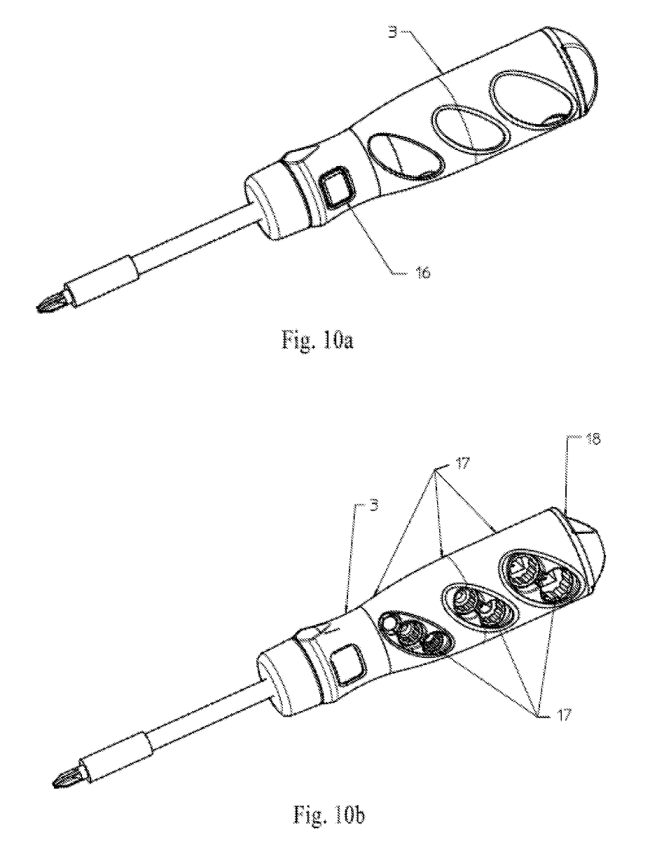

The present invention is differentiated from the prior art by its cartridge, which is designed to rotate within the handle around the Y-Y axis. In a first position shown in FIG. 10a, the bits are enclosed within the handle 4 and not accessible. In the prior art, the cartridge only moves laterally along the Y-Y axis for inserting the cartridge into the handle, and does not rotate around the Y-Y axis when fully installed. Its only function is to store the cartridges 9, while in contrast the present invention provides a means to access the bits through the handle 4 and while stored in the cartridge 9.

In a second position shown in 10b, the cartridge 9 is rotated 90 degrees around the Y-Y axis by pressing the release buttons 19 on each side of the handle to enable rotation of the handle around the Y-Y axis. Rotating the cartridge 6 from the top tab 21 allows access to all ten bits at once from both ends. Once rotated, bits 23 are presented from both the front and back 20. The bits 23 are exposed and accessible through a set of elliptical or a plurality of shaped holes 11n the handle 4. In the present invention, there is no need to remove the cartridge 9 from the handle 4 as is required with several other products known in the prior art.

Unlike the prior art cartridge, which have alternating holes at 90 degrees from each other for each of a set of bits, the cartridge 5 of the present invention comprises multiple receiving holes 11 for the bits 23 that are positioned on the same side of the cartridge's Y-Y axis in a plurality of configurations for retaining drive bits and sockets of various styles: phillips, flat, Torx, square, Robertson, sockets, etc.

The present invention can have alternating holes with other angles possible that can be used to make the bits accessible. In the present invention, the preferred embodiment illustrated in the figures shows 90°, but a plurality of angles can be used to allow the bits to be exposed.

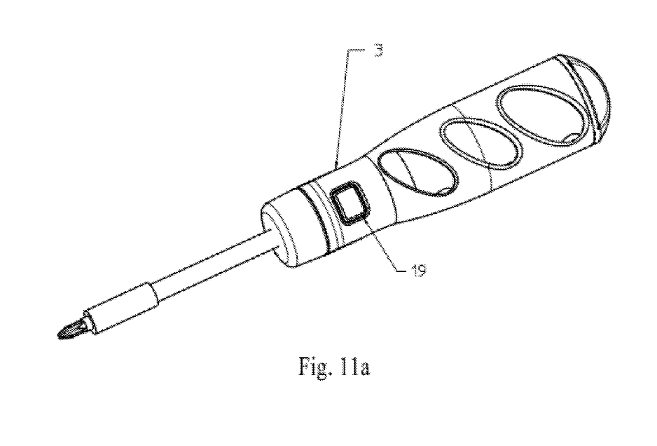

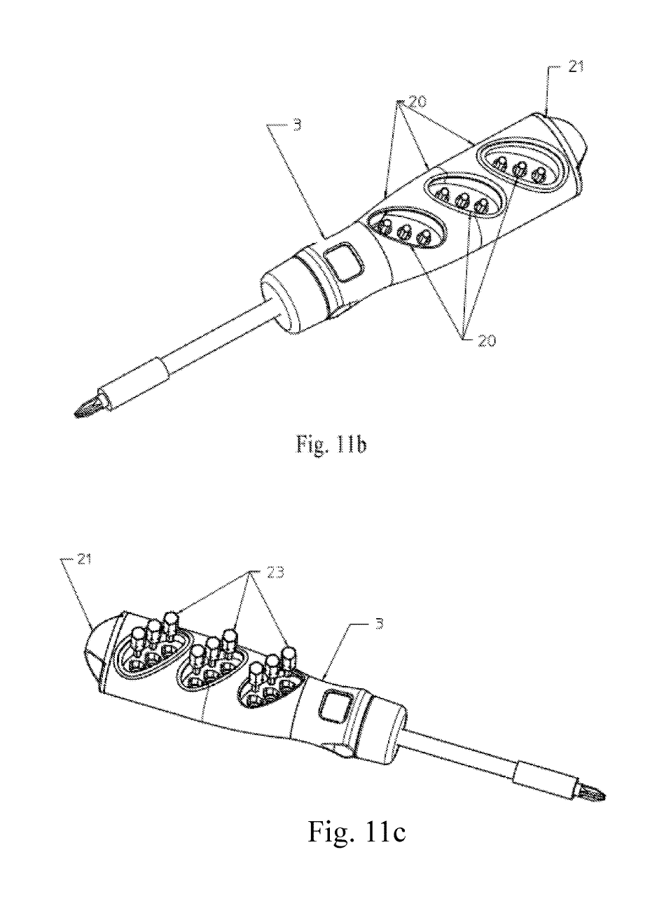

Unlike the prior art, the present invention comprises holes 11 in the handle 4 which are positioned on sides 180 degrees from each other. This allows access to both the front and back sides 17 of each hex bit when they are installed in the cartridge 5. As shown in FIGS. 11a and 11b, in a use mode a handle with or without over mold and bit storage cartridge installed, is shown in FIG. 11a. A release button 16 on both sides for a rotating cartridge 6 is taught and shown. In the bit replacement mode of FIG. 11b, rotating the cartridge 6 from the top tab 18 allows access to all 9 bits at once from both ends. Once rotated, bits are presented from both the front and back 20 as show in FIG. 11c. Again, there is no need to remove the cartridge 5 from handle 4 as is required with several other products known in the prior art.

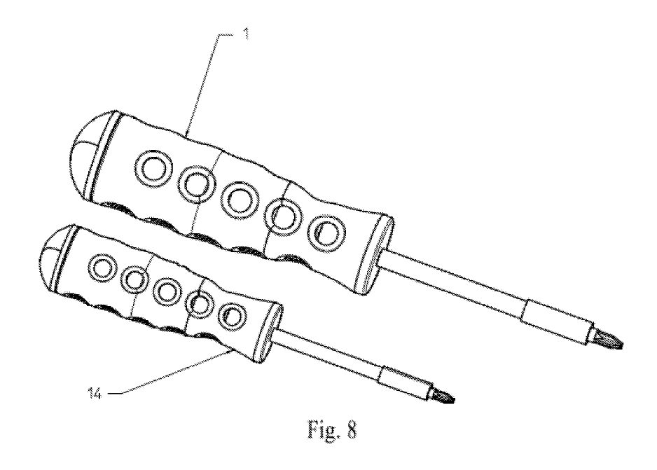

Now referring to FIG. 8, an alternative embodiment of the present invention representing a set of mini precision drivers 14 is shown. Scaling down the present invention offers all of the same features and benefits in a smaller version. This results in a big advantage over other products as it provides a more secure way to handle and use smaller precision bits.

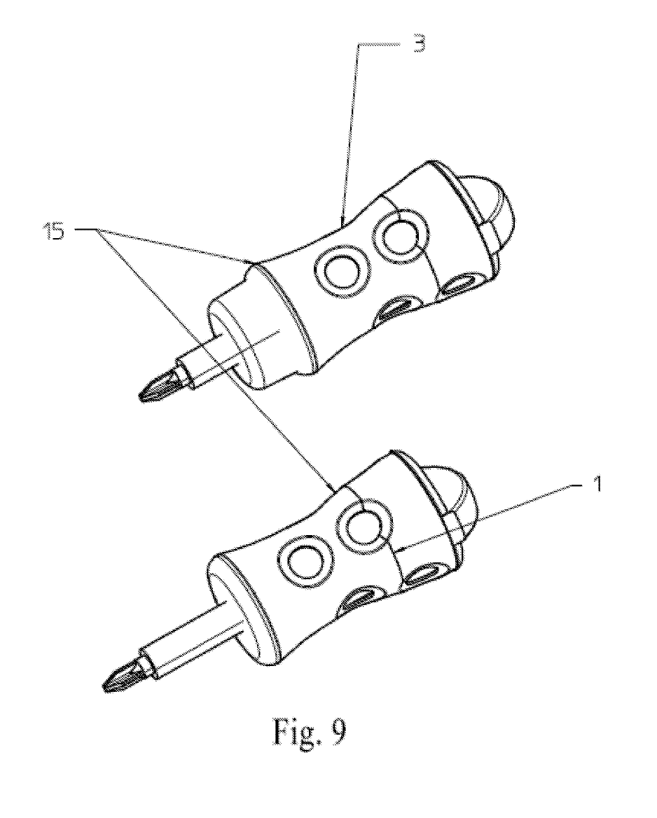

FIG. 9 illustrates a stubby driver 15 as an alternative embodiment of the present invention applied to a scaled down tool. Stubby drivers can be offered with a limited set of bits as their own SKU's or as bonus items in a set.

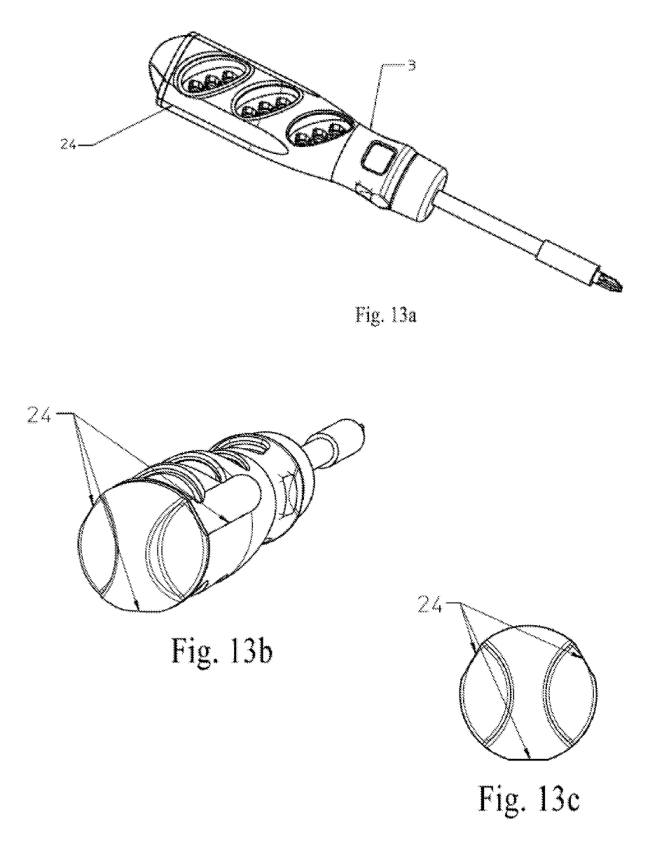

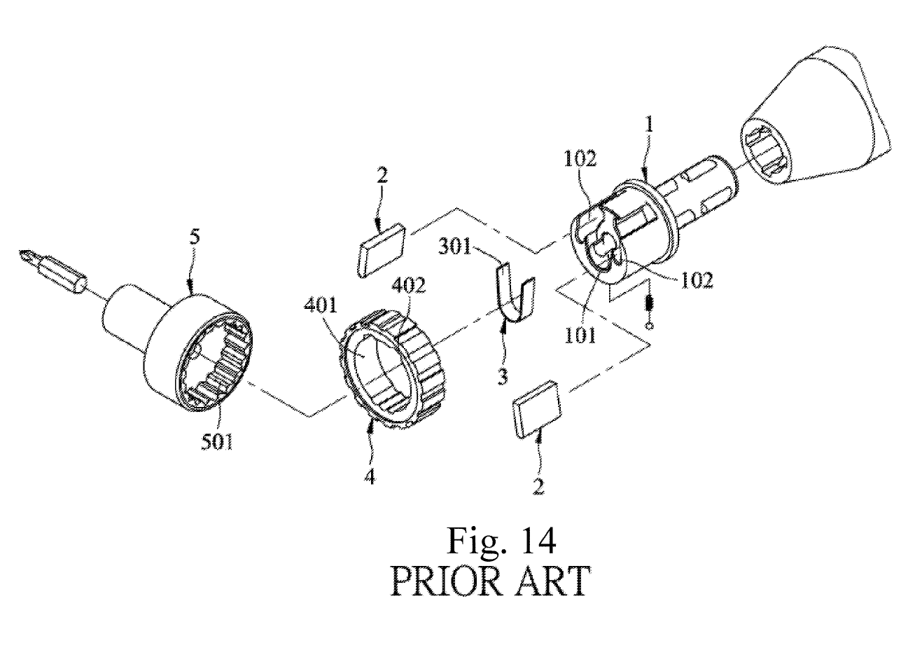

FIGS. 13a, 13b, and 13c a tri-lobe handle 24 shape as taught by an alternative embodiment of the present invention.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A bit driver device, comprising
a driver;
a driver handle;
a bit storage or “cartridge” that fits in the hollow portion of the driver handle;
the bit storage or “cartridge” enables access to bits from both ends of all bits at an angular rotated orientation to the main/long axis of the handle, while contained within the handle; and
the device remains in one piece rather than separating the assembly into two pieces, a handle and a cartridge during use.

2. The bit driver device of claim 1, comprising
a minimum of only two items to be manipulated during a bit change operation: the handle with integral, accessible bits, and the chosen bit.

3. The bit driver device of claim 1, comprising
the arrangement and spacing between bits allows the bits to be test fit to a fastener while in the cartridge/handle assembly.

4. The bit driver device of claim 1, comprising
changing a bit by directly coupling the receiving end of the shaft with the mating end of a bit;
this is done most commonly with a non-ratcheting version of the driver such that the drive shaft portion of the assembly is removable from the handle portion; and
then placed over the desired bit.

5. The bit driver device of claim 1, comprising
using a pushing force to couple the shaft and the bit until it bottoms out against the cartridge; and
the shaft is then twisted and pulled at the same time in order to extract the bit from the cartridge while keeping the tip firmly and fully coupled with the shaft receptacle.

6. The bit driver device of claim 5, comprising the aid of a magnet located at the bottom of the shaft bore.

7. The bit driver device of claim 1, wherein
the cartridge comprises flexible fins in a radial pattern around the bore for each bit; and
when the bit is rotated, the fins deflect in the direction of the twist and effectively reduce the amount of retention force.

8. The bit driver device of claim 1, wherein
the cartridge, which is designed to rotate within the handle around the long axis;
in a first position, the bits are enclosed within the handle and not accessible; and
in a second position, rotated 90 degrees around the long axis of the handle, the bits are exposed and accessible through a set of elliptical or a plurality of shaped holes in the handle.

9. The bit driver device of claim 8, wherein
the cartridge comprises multiple receiving holes for the bits that are positioned on the same side of the cartridge's long axis in a plurality of configurations for retaining drive bits and sockets of various styles.

10. The bit driver device of claim 9, wherein
drive bits and sockets of various styles include phillips, flat, Torx, square, and Robertson, sockets.

11. The bit driver device of claim 1, wherein
holes in the handle are positioned on sides 180 degrees from each other; and
providing access to both the front and back side of each hex bit when they are installed in the cartridge.

12. The bit driver device of claim 1, wherein
the shaft can be detached and inserted directly into a bit storage port.

13. The bit driver device of claim 1, wherein
where cartridges can be replaced with other cartridges offering a wide variety of drive style options as well as sockets in a bit cartridge.

14. The bit driver device of claim 1, wherein
the cartridge can be removed and positioned at the tip for bit replacement.

15. The bit driver device of claim 1, wherein
the bits can be removed by pushing them out from the tip end.

16. A ratcheting bit driver device, comprising
a driver;
a driver handle;
ratcheting mechanism;
a bit storage or “cartridge” that fits in the hollow portion of the driver handle;
the bit storage or “cartridge” enables access to bits from both ends of all bits at an angular rotated orientation to the main/long axis of the handle, while contained within the handle; and
the device remains in one piece rather than separating the assembly into two pieces, a handle and a cartridge during use.

17. The bit driver device of claim 16, comprising
a minimum of only two items to be manipulated during a bit change operation: the handle with integral, accessible bits, and the chosen bit.

18. The bit driver device of claim 16, comprising
the arrangement and spacing between bits allows the bits to be test fit to a fastener while in the cartridge/handle assembly.

19. The bit driver device of claim 16, comprising
changing a bit by directly coupling the receiving end of the shaft with the mating end of a bit;
this is done most commonly with a non-ratcheting version of the driver such that the drive shaft portion of the assembly is removable from the handle portion; and
then placed over the desired bit.

20. The bit driver device of claim 16, comprising
using a pushing force to couple the shaft and the bit until it bottoms out against the cartridge; and
the shaft is then twisted and pulled at the same time in order to extract the bit from the cartridge while keeping the tip firmly and fully coupled with the shaft receptacle.

21. The bit driver device of claim 20, comprising
the aid of a magnet located at the bottom of the shaft bore.

22. The bit driver device of claim 16, wherein
the cartridge comprises flexible fins in a radial pattern around the bore for each bit; and
when the bit is rotated, the fins deflect in the direction of the twist and effectively reduce the amount of retention force.

23. The bit driver device of claim 16, wherein
the cartridge, which is designed to rotate within the handle around the long axis of the handle;
in a first position, the bits are enclosed within the handle and not accessible;
in a second position, rotated 90 degrees around the long axis of the handle, the bits are exposed and accessible through a set of elliptical or a plurality of shaped holes in the handle.

24. The bit driver device of claim 23, wherein
the cartridge comprises multiple receiving holes for the bits that are positioned on the same side of the cartridge's long axis in a plurality of configurations for retaining drive bits and sockets of various styles.

25. The bit driver device of claim 24, wherein
drive bits and sockets of various styles include phillips, flat, Torx, square, and Robertson, sockets.

26. The bit driver device of claim 16, wherein
holes in the handle are positioned on sides 180 degrees from each other; and
providing access to both the front and back side of each hex bit when they are installed in the cartridge.

27. The bit driver device of claim 16, wherein
where cartridges can be replaced with other cartridges offering a wide variety of drive style options as well as sockets in a bit cartridge.

28. The bit driver device of claim 16, wherein
the cartridge can be removed and positioned at the tip for bit replacement.

29. The bit driver device of claim 16, wherein
the bits can be removed by pushing them out from the tip end.
